(19) United States
(12) Patent Application Publication
(10) Pub. No.: US 2025/0256354 A1
(43) Pub. Date: Aug. 14, 2025

(54) CONDUCTOR JOINING METHOD

(71) Applicant: HONDA MOTOR CO., LTD., Tokyo (JP)

(72) Inventors: Tomokatsu NISHIYAMA, Tokyo (JP); Ryuzo SAKAMOTO, Saitama (JP); Daisuke SUDO, Tokyo (JP)

(21) Appl. No.: 19/022,513

(22) Filed: Jan. 15, 2025

(30) Foreign Application Priority Data
Feb. 14, 2024 (JP) 2024-019996

(51) Int. Cl. B23K 26/21; H02K 15/33

(52) U.S. Cl. CPC B23K 26/21; H02K 15/33

(57) ABSTRACT

A conductor joining method includes: an initial-stage irradiation step in which an inner region of an end surface of each of first and second conductors is irradiated with laser light to form a pair of molten pools arranged side by side on the end surfaces of the first and second conductors in such a manner that an outer peripheral portion of each end surface forms a bank; a middle-stage irradiation step in which joint-side regions of the end surfaces of the first and second conductors which are close to each other are irradiated with laser light so that the molten pools are coupled to each other; and a late-stage irradiation step in which an entire end surface jointly configured by the end surfaces of the first and second conductors is irradiated with laser light in a substantially circular shape to form the molten pools into a hemispherical molten ball.

### TECHNICAL FIELD

The present invention relates to a conductor joining method, and more specifically relates to a conductor joining method for joining a first conductor and a second conductor by laser welding.

### BACKGROUND ART

In recent years, efforts to realize a low-carbon society or a carbon-neutral society are becoming more active, and in relation to vehicles, research and development on electrification technology are being conducted to reduce CO₂ emission and to improve energy efficiency. To popularize electric vehicles, it is important to reduce the manufacturing cost of electric motors (motors and/or generators) and to improve energy efficiency.

For cost reduction and energy efficiency improvement, a flat wire may be used in a coil wound around a stator core of an electric motor. To wind a flat wire around the teeth, there is known a method in which insulating films of tip end portions of a pair of flat wires inserted in a slot between each pair of adjacent teeth are stripped off, and tip end portions of the exposed conductors of the pair of flat wires are joined by laser welding using laser light irradiation.

As such a joining method, JP6390672B2 discloses a joining method in which end surfaces of first and second flat wires which are to be joined are irradiated with a laser beam, wherein the joining method includes: applying the laser beam in a loop shape inside the end surface of the first flat wire to form a molten pool; and applying the laser beam inside the end surface of the first flat wire while gradually increasing the diameter of a loop-shaped trajectory of the laser beam to allow the molten pool to reach the side surfaces of the end portions. Thereby, it is possible to fill the gap (clearance) between the side surfaces with the molten pool without the laser beam being applied between the side surfaces, whereby the laser beam is prevented from entering the gap and damaging insulating films of the flat wires.

However, the method described in JP6390672B2 assumes that the end surfaces of the first and second flat wires to be joined are at the same height and the gap between the side surfaces of the end portions of the first and second flat wires is small. On the other hand, after the first and second flat wires are inserted in the corresponding slots, the first and second flat wires are bent to bring the end portions close to each other, and this may place the end surfaces at different heights. Ensuring that the end surfaces are at the same height requires high processing accuracy, and this may lead to increase in the manufacturing cost.

### SUMMARY OF THE INVENTION

In view of the foregoing background, a primary object of the present invention is to provide a conductor joining method which can join the conductors reliably and at low cost even when there is a height difference between the end surfaces of the two flat wires to be joined.

To achieve the above object, one aspect of the present invention provides a conductor joining method for joining a first conductor (11A) and a second conductor (11B) by laser welding, the conductor joining method comprising: an initial-stage irradiation step in which an inner region (31) of an end surface of each of the first conductor and the second conductor is irradiated with a laser light to form a pair of molten pools (33) arranged side by side on the end surfaces of the first conductor and the second conductor in such a manner that an outer peripheral portion of each end surface forms a bank; a middle-stage irradiation step in which joint-side regions (32) of the end surfaces of the first conductor and the second conductor which are close to each other are irradiated with the laser light so that the pair of molten pools are coupled to each other; and a late-stage irradiation step in which an entire end surface jointly configured by the end surfaces of the first conductor and the second conductor is irradiated with the laser light in a substantially circular shape to form the pair of molten pools which are coupled to each other into a hemispherical molten ball (34).

According to this aspect, since the conductor joining method includes the initial-stage irradiation step, the middle-stage irradiation step, and the late-stage irradiation step, even when there is a height difference between the tip end portions of the conductors of the pair of flat wires from which the films are stripped off, it is possible to make the molten ball grow to an appropriate size without dropping. Thus, the conductors can be joined at low cost and reliably.

In the above aspect, preferably, in the initial-stage irradiation step, the inner region is irradiated with the laser light while the laser light is caused to weave in a loop manner.

According to this aspect, it is possible to efficiently form the molten pool in the inner region of the end surface.

In the above aspect, preferably, when the end surface of the first conductor is located at a higher position than the end surface of the second conductor, the joint-side region of the first conductor is irradiated with the laser light earlier than the joint-side region of the second conductor in the middle-stage irradiation step to cause the molten pool of the first conductor to flow to the molten pool of the second conductor.

According to this aspect, since the molten pool of the first conductor, which has a higher end surface, flows to the molten pool of the second conductor, which has a lower end surface, flowing of the molten pool into the gap between the conductors is suppressed.

In the above aspect, preferably, in the late-stage irradiation step, the molten ball is irradiated with the laser light to such an extent that the first conductor and the second conductor are hidden by the molten ball in plan view.

According to this aspect, the conductors can be reliably welded by the molten ball larger than the cross sections of the conductors.

According to the above aspect, it is possible to provide a conductor joining method which can join the conductors reliably and at low cost even when there is a height difference between the end surfaces of the two flat wires to be joined.

### BRIEF DESCRIPTION OF THE DRAWINGS

FIG. 1 is a sectional view of a stator of a rotating electric machinery according to an embodiment, in which the stator is in the middle of manufacture;

FIG. 2 is a perspective view of a pair of flat wires after bending process;

FIG. 3 is a diagram schematically showing how the flat wires are joined;

FIG. 4 is an explanatory diagram of a joining method according to the embodiment;

FIG. 5 is an explanatory diagram of end surfaces of the flat wires;

FIG. 6 is a diagram showing an irradiation trajectory according to a first modification of an initial-stage irradiation step;

FIG. 7 is a diagram showing an irradiation trajectory according to a second modification of the initial-stage irradiation step; and

FIG. 8 is a diagram showing an irradiation trajectory according to a modification of a middle-stage irradiation step.

### DETAILED DESCRIPTION OF THE INVENTION

In the following, an embodiment of the present invention will be described in detail with reference to the drawings.

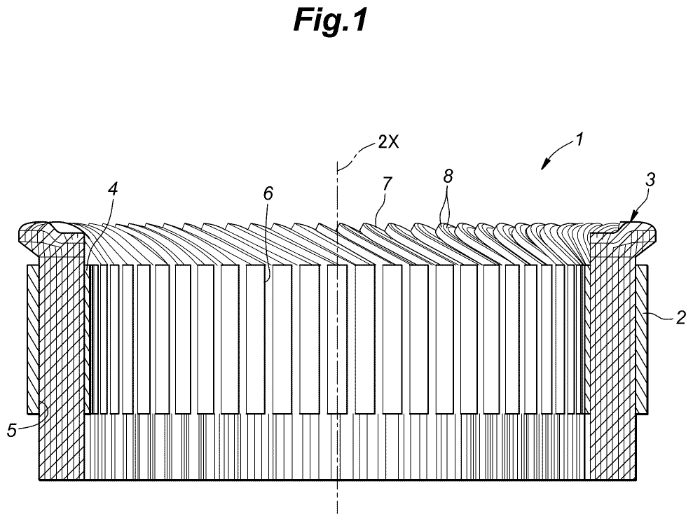

FIG. 1 is a sectional view of a stator 1 of a rotating electric machinery according to an embodiment, in which the stator 1 is in the middle of manufacture. The conductor joining method according to the present invention is executed when manufacturing the rotating electric machinery shown in FIG. 1. The rotating electric machinery includes the stator 1 and a rotor rotatably disposed inside the stator 1 and not shown in the drawing. The stator 1 is configured by including a stator core 2 and a coil 3. The stator core 2 has a cylindrical shape extending along an axis 2X, and this axis 2X coincides with the rotation axis of the rotor. Namely, the rotor is provided to be rotatable about the axis 2X of the stator core 2.

The stator core 2 is provided with multiple teeth 4 extending in the axial direction (in the up-down direction in FIG. 1) on a radially inner side. Each of the teeth 4 has a T-shape such that the tip end has a larger width than the base end, and the teeth 4 are arranged at equal intervals in the circumferential direction. Between mutually adjacent ones of the teeth 4, multiple slots 5 that penetrate the stator core 2 in the axial direction are formed to be arranged at equal intervals in the circumferential direction. Also, multiple slits 6 are formed on the inner circumferential surface of the stator core 2 by the tip ends of the mutually adjacent teeth 4. The slits 6 have a width smaller than the width of the slots 5 in the circumferential direction. Each slot 5 extends radially outward from the slit 6 formed on the inner circumferential surface of the stator core 2 such that the width of the slot 5 increases as the slot 5 extends radially outward. Note, however, that the slits 6 are not indispensable.

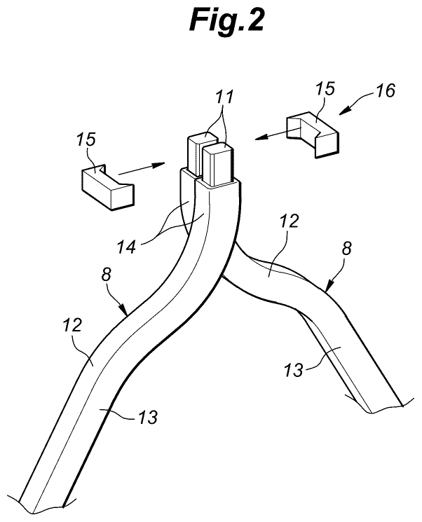

The coil 3 is obtained by joining multiple segment coils 7 by laser welding. Each segment coil 7 is obtained by bundling multiple coil elements (conductive wires) and shaping it into a substantially U-shape. Flat wires 8 each having a rectangular cross-sectional shape are used as the coil elements. Each flat wire 8 includes a linear conductor part 11 (FIG. 2) made of conductive material such as copper, for example, and a film 12 (FIG. 2) which is made of insulating material and covers the conductor part 11. The multiple segment coils 7 are arranged annularly to overlap in the circumferential direction and in this state are inserted into the slots 5 along the axis 2X of the stator core 2.

FIG. 2 is a perspective view of a pair of flat wires 8 after bending process. Note that FIG. 2 shows a part of the flat wires 8 protruding from the lower side of the stator core 2 by inverting the stator core 2 shown in FIG. 1 in the axial direction. As shown in FIG. 2, at both end portions of each flat wire 8 protruding from the slots 5 of the stator core 2, the films 12 are stripped off to expose the conductor parts 11. After the insertion into the slots 5, each end portion of each flat wire 8 is bent in the circumferential direction to be joined to another corresponding one of the flat wires 8. As a result of the bending, the part of each flat wire 8 protruding from the slot 5 has an inclined part 13 which is inclined relative to the axis 2X of the stator core 2 in the circumferential direction and a parallel part 14 which extends from an end portion of the inclined part 13 in parallel with the axis 2X of the stator core 2 and forms an end portion.

The end portions of each pair of flat wires 8 which are disposed close to each other as a result of the bending process are arranged in parallel with each other. Note, however, that due to spring back caused in the flat wires 8 after the bending process, the end portions of the flat wires 8 may deviate from the desired positions in the circumferential direction. This may result in separation of the end portions of the two flat wires 8 to be joined, and the flat wires 8 may become unable to be joined. To solve this problem, the two flat wires 8 are clamped by a clamp jig 16 including a pair of clamp main bodies 15, and are joined to each other in the state in which the end portions are held close to each other. As the clamp jig 16, for example, clamp jigs disclosed in JP6483079B2 and JP6680867B2 filed by the Applicant or clamp jigs having configurations similar to them may be used.

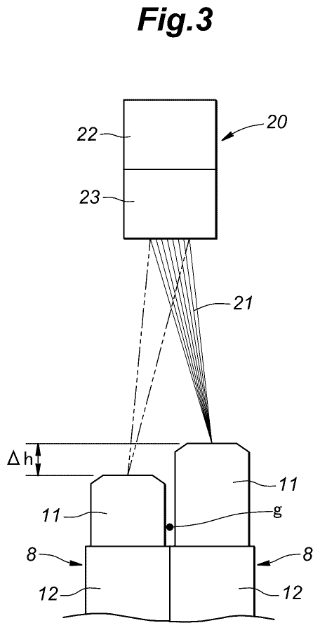

By using the clamp jig 16, the end portions of the pair of flat wires 8 are aligned in the circumferential direction and are disposed close to each other so as to oppose each other in the radial direction of the stator core 2. Note, however, that since the end portions of the pair of flat wires 8 are each provided with the film 12 on the lower portion of the parallel part 14 and on the inclined part 13, there is a small gap g (FIG. 3) between the conductor parts 11. Preferably, the end surfaces of the pair of flat wires 8 are disposed at the same height (at the distance from the end surface of the stator core 2 along the axis 2X of the stator core 2). However, since the clamp jig 16 cannot adjust the positions of the conductor parts 11 in the height direction, the end surfaces of the pair of flat wires 8 may be disposed at different heights with a slight difference Δh (FIG. 3). The end portions of the flat wires 8 disposed in such a manner are reliably joined by using the conductor joining method described in the following.

Next, one embodiment of a concrete method for laser-welding the end portions of the conductor parts 11 of the flat wires 8 will be described. FIG. 3 is a diagram schematically showing how the flat wires 8 are joined. The conductor joining method according to the present embodiment is conducted by using a laser welding device 20 shown in FIG. 3 in a state in which the pair of flat wires 8 are disposed to be close to each other with the end surfaces of the conductor parts 11 facing upward. Specifically, the pair of conductor parts 11 are joined to each other by laser welding in which the laser welding device 20 irradiates the end surfaces of the pair of flat wires 8 (the end surfaces of the conductor parts 11) with a laser light 21. The conductor joining method includes an initial-stage irradiation step, a middle-stage irradiation step, and a late-stage irradiation step.

The laser welding device 20 includes a laser oscillator 22 which can emit a laser beam with a wavelength less than or equal to 100 μm, for example, and has high light condensing property, and a Galvano-scanning laser head 23 which can perform scanning with the laser light 21 emitted from the laser oscillator 22 at a rate of 500 mm/see or higher, for example. The type of the laser oscillator 22 is not particularly limited, and it may be a fiber laser, a YAG laser, a CO₂ laser, a semiconductor pumped laser, or the like. In the illustrated example, the laser welding device 20 includes one laser oscillator 22 and one laser head 23, and sequentially irradiates the end surfaces of the pair of flat wires 8 with the laser light 21. In another embodiment, the laser welding device 20 may include two laser oscillators 22 and two laser heads 23, and may simultaneously irradiate the end surfaces of the pair of flat wires 8 with the laser lights 21.

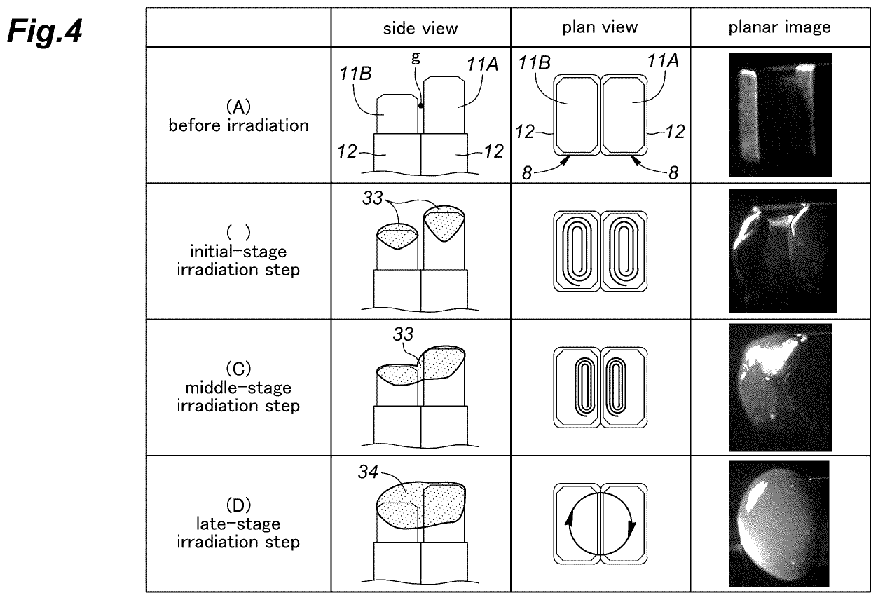

FIG. 4 is an explanatory diagram of a joining method according to the embodiment. FIG. 4 shows a side view, a plan view, and a planar image for each of (A) before irradiation, (B) an initial-stage irradiation step, (C) a middle-stage irradiation step, and (D) a late-stage irradiation step. The conductor joining method is performed in order of the initial-stage irradiation step, the middle-stage irradiation step, and the late-stage irradiation step. In the following, these steps are described in order. Note that in the plan view for each irradiation step in FIG. 4, trajectories of the laser light 21 are shown.

As shown in (A) of FIG. 4, before irradiation, the conductor parts 11 at the end portions of the pair of flat wires 8 are disposed to be close to each other via a gap g substantially corresponding to twice the thickness of the film 12, with the upper end surfaces thereof being positioned at different heights. In the following, the conductor part 11 of the right flat wire 8 in the drawing is referred to as the first conductor part 11A, and the conductor part 11 of the left flat wire 8 is referred to as the second conductor part 11B. When not distinguished from each other, they may be simply referred to as the conductor parts 11, the both conductor parts 11, or the like. The end surface of the first conductor part 11A is at a higher position than the end surface of the second conductor part 11B.

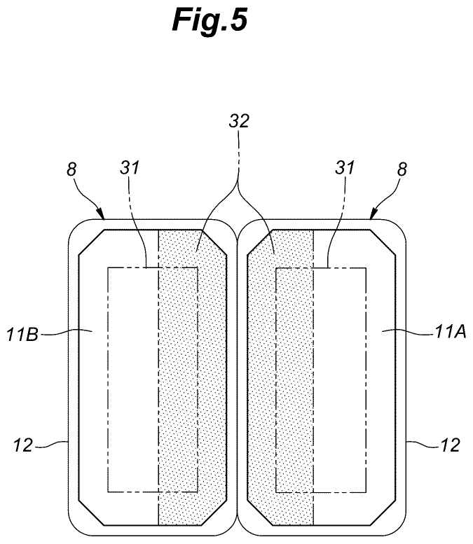

Here, with reference to FIG. 5, description is made of the end surfaces of the conductor parts 11 of the flat wires 8. FIG. 5 is an explanatory diagram of the end surfaces of the conductor parts 11 of the flat wires 8. As shown in the drawing, the conductor part 11 of each flat wire 8 is substantially rectangular in plan view. In this description, an inner region (the region surrounded by an imaginary line) of the end surface of each conductor part 11 is referred to as an inner region 31. The inner region 31 does not extend to the outer edge of the end surface. The ratio of the area of the inner region 31 to the area of the end surface of the conductor part 11 may be 30% to 70%, for example, though it is not limited thereto.

A region of the end surface of each conductor part 11 on the side of the other conductor part 11 to be joined thereto (the region partitioned by an imaginary line and provided with hatching) is referred to as a joint-side region 32 in the present description. The joint-side region 32 of each conductor part 11 does not include a region on the side opposite from the other conductor part 11 to be joined thereto. The ratio of the area of the joint-side region 32 to the area of the end surface of the conductor part 11 may be 20% to 60%, for example, though it is not limited thereto. Also, the joint-side region 32 may have a part overlapping with the inner region 31 or may not have a part overlapping with the inner region 31.

As shown in (B) of FIG. 4, in the initial-stage irradiation step, the inner regions 31 (see FIG. 5) of the end surfaces of the both conductor parts 11 are irradiated with the laser light 21. For example, the laser welding device 20 irradiates the inner region 31 of the end surface of the first conductor part 11A with the laser light 21, and thereafter irradiates the inner region 31 of the end surface of the second conductor part 11B with the laser light 21. In the example shown in (B) of FIG. 4, the laser welding device 20 irradiates the inner region 31 of the end surface of each conductor part 11 with the laser light 21 in a spiral pattern to continuously draw circles of different sizes. The laser welding device 20 may irradiate each of the end surface of the first conductor part 11A and the end surface of the second conductor part 11B with the laser light 21 once, or may irradiate each of them with the laser light 21 twice or three times.

Due to the irradiation with the laser light 21 in the initial-stage irradiation step, as shown in the side view of (B) of FIG. 4, each of the end portion of the first conductor part 11A and the end portion of the second conductor part 11B melts inside the inner region 31 but does not melt in the outer region. In other words, the outer region of each conductor part 11 forms a bank, and a molten pool 33 is formed in the inner region 31. In this way, a pair of molten pools 33 that are arranged side by side are formed on the end surfaces of the conductor parts 11.

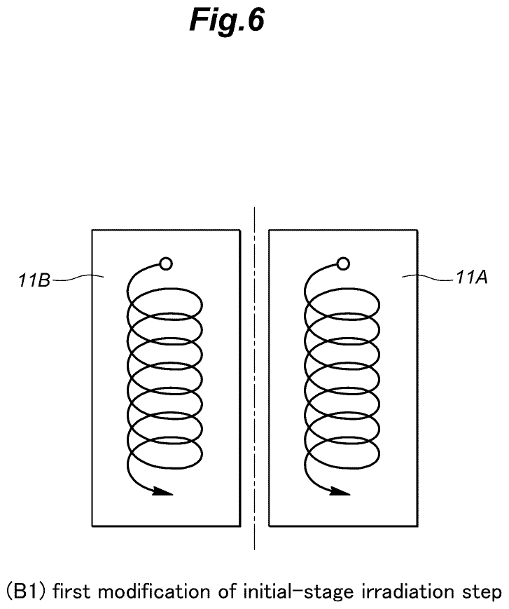

FIG. 6 is a diagram showing an irradiation trajectory according to a first modification of the initial-stage irradiation step. In FIG. 6, the start point of the trajectory of the laser light 21 is indicated by a circle, and the direction of the trajectory is indicated by an arrow. As shown in FIG. 6, the laser welding device 20 may irradiate the inner region 31 of the end surface of each conductor part 11 with the laser light 21 so as to continuously draw circles of the same size while shifting in one direction. In this way, the laser welding device 20 irradiates the inner region 31 of the end surface with the laser light 21 while causing the laser light 21 to weave in a loop manner, and this makes it possible to efficiently form the molten pool 33 in the inner region 31 of the end surface.

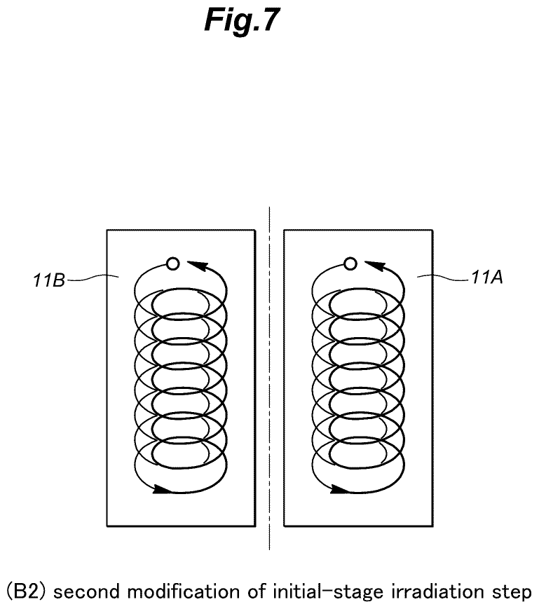

FIG. 7 shows an irradiation trajectory according to a second modification of the initial-stage irradiation step. As shown in FIG. 7, the laser welding device 20 may irradiate the inner region 31 of the end surface of each conductor part 11 with the laser light 21 so as to continuously draw circles of the same size while shifting in one direction and further to continuously draw circles of the same size while shifting in the opposite direction. In this case also, it is possible to efficiently form the molten pool 33 in the inner region 31 of the end surface.

Next, as shown in (C) of FIG. 4, in the middle-stage irradiation step, the joint-side regions 32 (see FIG. 5) of the end surfaces of the both conductor parts 11 are irradiated with the laser light 21. The joint-side region 32 of the first conductor part 11A is a part of the end surface of the first conductor part 11A on the side of the second conductor part 11B. The joint-side region 32 of the second conductor part 11B is a part of the end surface of the second conductor part 11B on the side of the first conductor part 11A. For example, the laser welding device 20 irradiates the joint-side region 32 of the end surface of the first conductor part 11A with the laser light 21, and thereafter irradiates the joint-side region 32 of the end surface of the second conductor part 11B with the laser light 21.

In the example shown in (C) of FIG. 4, the laser welding device 20 irradiates the joint-side region 32 of the end surface of each conductor part 11 with the laser light 21 so as to draw one or more elongated circles. The one or more elongated circles may consist of a single elongated circle or may consist of two or three elongated circles that are nested. Also, the laser welding device 20 may irradiate each of the end surface of the first conductor part 11A and the end surface of the second conductor part 11B with the laser light 21 once or may irradiate each of them with the laser light 21 twice or three times.

Due to the irradiation with the laser light 21 in the middle-stage irradiation step, the bank part of the first conductor part 11A on the side of the second conductor part 11B and the bank part of the second conductor part 11B on the side of the first conductor part 11A melt. Thereby, the pair of molten pools 33 are coupled to make one large molten pool 33.

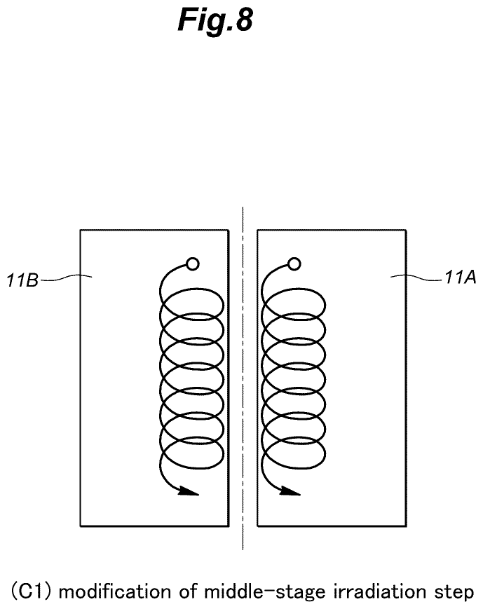

FIG. 8 shows an irradiation trajectory according to a modification of the middle-stage irradiation step. As shown in FIG. 8, the laser welding device 20 may irradiate the joint-side region 32 of the end surface of each conductor part 11 with the laser light 21 so as to continuously draw circles of the same size while shifting in one direction. In this way, the laser welding device 20 irradiates the joint-side region 32 with the laser light 21 while causing the laser light 21 to weave in a loop manner, and this can efficiently melt the bank part of the joint-side region 32 of the end surface.

As shown in FIG. 3, in the present embodiment, the laser welding device 20 irradiates the end surface of the first conductor part 11A, which is at a higher position than the end surface of the second conductor part 11B, with the laser light 21 earlier than the end surface of the second conductor part 11B. Therefore, as shown in (C) of FIG. 4, the bank of the first conductor part 11A melts earlier than the bank of the second conductor part 11B, and the molten pool 33 of the first conductor part 11A flows to the molten pool 33 of the second conductor part 11B. In this way, in the middle-stage irradiation step, the molten pool 33 of the first conductor part 11A, which has a higher end surface, is caused to flow to the molten pool 33 of the second conductor part 11B, which has a lower end surface, whereby flowing of the molten pool 33 into the gap g between the conductor parts 11 is suppressed.

As shown in (D) of FIG. 4, in the late-stage irradiation step, the laser welding device 20 irradiates the entire end surface jointly configured by the end surface of the first conductor part 11A and the end surface of the second conductor part 11B with the laser light 21 in a substantially circular shape, and thereby forms the pair of molten pools which are coupled to each other 33 into a hemispherical molten ball 34. When the molten ball 34 is cooled and is solidified, the first conductor part 11A and the second conductor part 11B are joined to each other.

In the late-stage irradiation step, the laser welding device 20 irradiates the molten ball 34 with the laser light 21 to such an extent that the first conductor part 11A and the second conductor part 11B are hidden by the molten ball 34 in plan view. Therefore, the conductor parts 11 are reliably welded by the molten ball 34 larger than the cross section of the conductor parts 11.

As described above, the conductor joining method of the present embodiment includes the initial-stage irradiation step, the middle-stage irradiation step, and the late-stage irradiation step. Therefore, even when the gap g and the height difference Δh exist between the tip end portions of the conductor parts 11 of the pair of flat wires 8 from which the films 12 are stripped off, it is possible to make the molten ball 34 grow to an appropriate size without dropping. Thus, the conductor parts 11 can be joined at low cost and reliably.

Concrete embodiments have been described in the foregoing, but the present invention can be modified in various ways without being limited to the above embodiments or modifications. For example, in the above embodiment, in the initial-stage irradiation step and the middle-stage irradiation step, the laser welding device 20 irradiates the end surface of the first conductor part 11A with the laser light 21 and thereafter irradiates the end surface of the second conductor part 11B with the laser light 21. In another embodiment, in at least one of the initial-stage irradiation step and the middle-stage irradiation step, the laser welding device 20 may irradiate the end surface of the second conductor part 11B with the laser light 21 earlier. Also, the laser welding device 20 may be provided with two laser heads 23, and may simultaneously irradiate the end surface of the first conductor part 11A and the end surface of the second conductor part 11B with the laser lights 21. Besides, the structure, arrangement, number, material, or the like of each member or part, the concrete method, numerical values, shape of the trajectory, etc. for each step may be appropriately changed without departing from the spirit of the present invention. Further, parts or the whole of the configuration of the above embodiment and the modifications thereof may be combined to each other. Also, not all of the components shown in the foregoing embodiments are necessarily indispensable and they may be selectively adopted as appropriate.

1. A conductor joining method for joining a first conductor and a second conductor by laser welding, the conductor joining method comprising:
an initial-stage irradiation step in which an inner region of an end surface of each of the first conductor and the second conductor is irradiated with a laser light to form a pair of molten pools arranged side by side on the end surfaces of the first conductor and the second conductor in such a manner that an outer peripheral portion of each end surface forms a bank;
a middle-stage irradiation step in which joint-side regions of the end surfaces of the first conductor and the second conductor which are close to each other are irradiated with the laser light so that the pair of molten pools are coupled to each other; and
a late-stage irradiation step in which an entire end surface jointly configured by the end surfaces of the first conductor and the second conductor is irradiated with the laser light in a substantially circular shape to form the pair of molten pools which are coupled to each other into a hemispherical molten ball.

2. The conductor joining method according to claim 1, wherein in the initial-stage irradiation step, the inner region is irradiated with the laser light while the laser light is caused to weave in a loop manner.

3. The conductor joining method according to claim 1, wherein when the end surface of the first conductor is located at a higher position than the end surface of the second conductor, the joint-side region of the first conductor is irradiated with the laser light earlier than the joint-side region of the second conductor in the middle-stage irradiation step to cause the molten pool of the first conductor to flow to the molten pool of the second conductor.

4. The conductor joining method according to claim 1, wherein in the late-stage irradiation step, the molten ball is irradiated with the laser light to such an extent that the first conductor and the second conductor are hidden by the molten ball in plan view.
